(19) United States
(12) Patent Application Publication
(10) Pub. No.: US 2017/0082248 A1
(43) Pub. Date: Mar. 23, 2017

(54) LED-BASED LINEAR LAMPS AND LIGHTING ARRANGEMENTS

(71) Applicant: Intematix Corporation, Fremont, CA (US)

(72) Inventor: Scott WEST, Pleasanton, CA (US)

(21) Appl. No.: 15/273,212

(22) Filed: Sep. 22, 2016

Related U.S. Application Data
(60) Provisional application No. 62/222,775, filed on Sep. 23, 2015.
(60) Provisional application No. 62/251,616, filed on Nov. 5, 2015.

(51) Int. Cl. F21K 9/275; F21V 7/04; F21V 29/85; F21V 13/08; F21V 9/16; F21V 19/00; F21V 3/02; F21V 9/08; F21V 29/70

(52) U.S. Cl. CPC F21K 9/275; F21V 9/08; F21V 7/04; F21V 29/85; F21V 29/70; F21V 9/16; F21V 19/003; F21V 3/02; F21V 13/08; F21Y 2115/10

(57) ABSTRACT

An LED-based linear lamp comprises a linear array of LEDs and an elongated wavelength conversion component. The wavelength conversion component comprises first and second wavelength conversion wall portions that extend along the direction of elongation of the component and which comprise a photoluminescence material and a light reflective portion that extends along the direction of elongation of the component. The light reflective portion separates the first and second wavelength conversion portions. Together, the light reflective, first and second wavelength conversion portions define an interior volume with a cross-section having a line of symmetry through the light reflective portion and the component is mountable over the linear array of LEDs such that the LEDs are housed within the interior volume.

### CROSS-REFERENCE TO RELATED APPLICATIONS

This application claims the benefit of priority to U.S. Provisional Application No. 62/222,775, filed 23 Sep. 2015 and U.S. Provisional application No. 62/251,616, filed 5 Nov. 2015, each of which are hereby incorporated by reference in their entirety.

### FIELD

This disclosure relates to LED-based linear lamps and lighting arrangements. In particular, although not exclusively, embodiments of the invention concern LED-based linear lamps and lighting arrangements including remote photoluminescence wavelength conversion. Embodiments of the invention concern linear lamps for use in troffer lighting arrangements.

### BACKGROUND

A common lamp that has achieved great commercial success is the linear fluorescent tube lamp which is an elongated lamp with an isotropic light emission along the length of the lamp. Fluorescent tube lamps are commonly used in office, commercial, industrial and domestic applications and are available in standard sizes such as T5, T8, and T12 lamps.

A lighting arrangement that is commonly used in office and commercial applications is a ceiling-recess or troffer that is mounted within a modular suspended (dropped) ceiling. Other, linear lighting arrangements include suspended linear arrangements that can be direct only (downward light emitting) or direct/indirect (lighting both the workspace in a downward direction and the ceiling in an upward direction for indirect lighting. Surface mount linear fixtures, often called wraparound lights or wrap lights, are used in both office, industrial and domestic spaces. These are typically mounted directly to the surface of the ceiling or wall. Task lighting and under-cabinet fixtures also commonly use linear lamps as the light source.

FIG. 1 shows an example of a traditional troffer 2 that is used to house fluorescent tube lamps in a modular suspended (dropped) ceiling. The interior of the troffer body 4 includes lamp holders (connectors) on both lateral ends of the arrangement to receive linear fluorescent tubes 6. To achieve desired lighting performance, most troffers are configured to receive several fluorescent tubes, since a single conventional tube by itself cannot usually generate enough light for typical applications. To maximize light emission, the interior surface of the troffer body 4 is light reflective. The troffer can include a removable panel 8 to allow for insertion and replacement of the fluorescent tubes 6. In addition, the panel 8 also provides a location to include a diffuser within the lighting arrangement to improve the uniformity of emission of the arrangement and to reduce glare from the fluorescent tubes.

While traditional fluorescent tube based troffers, suspended linear, wraparound lights and under-cabinet lighting arrangements are very common and exist in almost every commercial and office building, there are disadvantages with such lighting configurations; namely, there non-uniform emission characteristics and the appearance of glare from the fluorescent tubes.

In recent years, white light emitting LEDs (“white LEDs”) have become increasingly popular and more commonly used to replace conventional fluorescent, compact fluorescent and incandescent light sources. White LEDs generally include one or more photoluminescence materials (typically inorganic phosphor materials), which absorb a portion of the radiation emitted by the LED and re-emit light of a different color (wavelength). The phosphor material may be provided as a layer on, or incorporated within a wavelength conversion component that is located remotely from the LED. The latter arrangements are commonly referred to as “remote phosphor” arrangements. As is known LED-based linear lamps can comprise a linear array of discrete white LEDs or a remote phosphor arrangement comprising a linear array of blue LEDs with a linear remote wavelength conversion component overlaying the LEDs. Whilst such LED-based linear lamps provide many benefits over traditional fluorescent lamps, such as improved efficiency and longer life expectancy, they possess a substantially Lambertian emission characteristic which can result in pronounced hot spots when used in troffer applications.

The present invention arose in an endeavor to provide LED-based linear lamps that in troffer-type applications, at least in part, improve the uniformity of emission and reduce the appearance of hot spots.

### SUMMARY OF THE INVENTION

Embodiments of the invention pertain to linear lamps that utilize an array of solid-state light emitting devices, typically LEDs (Light Emitting Diodes), in combination with an elongated optical component to generate a desired emission characteristic and to reduce the appearance of hot spots associated with the LEDs. The LED-based linear lamps of the invention at least in part overcome the problems associated with conventional fluorescent lamp.

In some embodiments, the elongated optical component additionally functions as a wavelength conversion component that includes one or more photoluminescence materials, typically phosphors, to convert light generated by the LEDs into white light. It will be appreciated that in such remote phosphor embodiments the elongated component has a dual function of generating the required color of light and the desired emission characteristic.

According to one embodiment, an elongated wavelength conversion component having a direction of elongation, comprises: a first wavelength conversion portion extending along the direction of elongation and comprising at least one photoluminescence material; a second wavelength conversion portion extending along the direction of elongation and comprising at least one photoluminescence material; and a light reflective portion extending along the direction of elongation, wherein the light reflective portion separates the first and second wavelength conversion portions. The provision of a light reflective portion located (disposed) between the wavelength conversion portions increases light emission to the sides of the component whilst simultaneously reducing light emission in directions orthogonal thereto. A linear lamp based on such a component finds particular application in lighting arrangements, such as troffers, which require a uniform wide area emission of light to fill large area reflectors of the troffer body.

In some embodiments, the light reflective portion and/or the first and second wavelength conversion portions extend along the entire length of the component in the direction of elongation.

For ease of fabrication, each of the light reflective portion and the first and second wavelength conversion portions can have a consistent (constant) cross-section along the entire length of the component in the direction of elongation. Alternatively, the light reflective portion and the first and second wavelength conversion portions can define consistent exterior dimensions along the entire length of the component in the direction of elongation. In other embodiments, at least one of the light reflective portion and the first and second wavelength conversion portions does not have a consistent cross-section along the entire length of the component in the direction of elongation.

In some embodiments, the light reflective portion and the first and second wavelength conversion portions define a cross-section having a line of symmetry through the light reflective portion. Such geometry provides a light emission characteristic that is symmetrical about the light reflective portion.

At least one of the first wavelength conversion portion, second wavelength conversion portion and light reflective portion may have a concave form. For example, the light reflective portion and the first and second wavelength conversion portions can define an interior volume and the light reflective portion may have a concave form such that an inner surface of the light reflective portion projects in to the interior volume of the wavelength conversion component. Alternatively, at least one of the first wavelength conversion portion, second wavelength conversion portion and light reflective portion may have a convex form. For example, the light reflective portion can have a convex form and project in a direction away from the interior volume.

Each of the first and second wavelength conversion portions can have a substantially linear form. Alternatively, each of the first and second wavelength conversion portions can have an arcuate form. The first and second wavelength conversion portions can have a concave form such that an inner surface of each portion projects in to the interior volume of the component. Alternatively, the first and second wavelength conversion portions can have a convex form.

In some embodiments, the light reflective portion and the first and second wavelength conversion portions define a cross-section that is generally zig-zag in form; in that it has a cross-section that generally resembles for example a letter W. In other embodiments, the light reflective portion and the first and second wavelength conversion portions define a cross-section that is generally v-shaped or elliptical in form.

The photoluminescence material, which can typically comprise an inorganic phosphor material, can be incorporated into and homogeneously distributed throughout the first and second wavelength conversion portions. Alternatively and/or in addition, the photoluminescence material can be provided as a layer on a surface of the first and second wavelength conversion portions. Additionally, photoluminescence material can be provided on an inner surface of the light reflective portion.

For ease of fabrication, the various portions of the wavelength conversion component can be integrally formed as a unitary component. In a preferred embodiment, the component is formed as a unitary component by co-extruding the light reflective portion and the first and second wavelength conversion portions. Alternatively, the component may be formed by injection molding. Some of the advantages associated with integrally forming the wavelength conversion component as a unitary component include ease of manufacture, improved robustness of the component, reduced costs of manufacture, and speed of manufacture.

Preferably, the various regions of the wavelength conversion component comprise polycarbonate.

Other embodiments of the invention pertain to LED-based lamps that utilize the wavelength conversion component of the invention. According to one embodiment, an LED-based lamp comprises: a linear array of LEDs operable to generate excitation light and an elongated wavelength conversion component having a direction of elongation, comprising: a first wavelength conversion portion extending along the direction of elongation and comprising at least one photoluminescence material which is excitable by the excitation light; a second wavelength conversion portion extending along the direction of elongation and comprising at least one photoluminescence material which is excitable by the excitation light; and a light reflective portion extending along the direction of elongation, wherein the light reflective portion separates the first and second wavelength conversion portions, wherein the light reflective portion, the first wavelength conversion portion and the second wavelength conversion portions define an interior volume and a cross-section having a line of symmetry through the light reflective portion, and wherein the wavelength conversion component is mountable over the linear array of LEDs such that the LEDs are housed within the interior volume. Typically, a majority, if not all, light emitted from the lamp passes through one of the first and second wavelength conversion portions.

In preferred embodiments, the component is mountable over the linear array of LEDs such that light reflective portion overlays the principal emission axis of the LEDs.

In some embodiments, the wavelength conversion component is configured such that the lamp generates between about 75% and about 95%, preferably about 90%, of the total emitted light over angle greater than about ±30° to the line of symmetry of the component. The wavelength conversion component can be configured such that the lamp generates about 40% of the total emitted light over angle between about ±55° and about ±90° to the line of symmetry of the component. The wavelength conversion component can be configured such that the lamp generates about 10% of the total emitted light over angle between about ±90° and ±55° to the line of symmetry of the component.

Other embodiments of the invention pertain to lighting arrangements that utilize the LED-based lamps of the invention. According to an embodiment of the invention, a lighting arrangement comprises: a housing having a light reflective interior surface and at least one LED-based lamp as described above that is located within the housing. A particular advantage of lighting arrangements utilizing lamps in accordance with embodiments of the invention is that due to the enhanced side emission characteristic of the lamps this provides a substantial improvement in emission uniformity from the entire arrangement. A further advantage is that by tailoring the side emission characteristic this enables lighting arrangements to be constructed requiring fewer LED-based linear lamps and which have a shallower profile (i.e. shallower housing) as compared with the known arrangements. For example, it is possible to construct a two foot by two foot troffer using only two LED-based linear lamps with an overall thickness of about two inches.

In the foregoing embodiments, the interior volume of the elongated wavelength conversion component can comprise a cavity filled with air. In any embodiment of the invention, the interior volume can comprise a light transmissive medium such as for example a polycarbonate or silicone material. Preferably, the light transmissive medium comprises a material with an index of refraction which is the same as or substantially matches the index of refraction of the first and second wavelength conversion portions. Such an arrangement eliminates the air-conversion portion interface index of refraction mismatch and assists in coupling light into the wavelength conversion portions.

Whilst the present invention arose in relation to linear lamps that utilize a remote wavelength conversion component to generate white light, the elongated component of the invention also finds utility in applications that use white LEDs. In such applications the one or more photoluminescence materials of the wavelength conversion regions is replaced with a light scattering material. According to such an embodiment, an elongated optical component having a direction of elongation, comprises: a first light scattering portion extending along the direction of elongation and comprising a light scattering material; a second light scattering portion extending along the direction of elongation and comprising a light scattering material; and a light reflective portion extending along the direction of elongation, wherein the light reflective portion separates the first and second light scattering portions.

The light scattering material, which is typically in the form of light scattering particles, is preferably incorporated into and homogeneously distributed throughout the first and second light scattering portions of the component. Alternatively and/or in addition, the light scattering material can be provided as a layer on a surface of the first and second light scattering portions. The light scattering material can comprise: zinc oxide, titanium dioxide, barium sulfate, magnesium oxide, silicon dioxide, aluminum oxide, zirconium dioxide or mixtures thereof.

For ease of fabrication, the light reflective portion and/or the first and second light scattering portions can extend along the entire length of the component in the direction of elongation. Each of the light reflective portion and the first and second light scattering portions can have a consistent cross-section along the entire length of the component in the direction of elongation. The light reflective portion and the first and second light scattering portions can define consistent exterior dimensions along the entire length of the component in the direction of elongation. In other embodiments, at least one of the light reflective portion and the first and second light scattering portions does not have a consistent cross-section along the entire length of the component in the direction of elongation.

Preferably, the light reflective portion and the first and second light scattering portions define a cross-section having a line of symmetry through the light reflective portion. Such an arrangement ensures a symmetrical emission characteristic about the light reflective portion.

In some embodiments, the light reflective portion and the first and second light scattering portions define an interior volume and the light reflective portion has a concave form such that an inner surface of the light reflective portion projects in to the interior volume of the component. Alternatively, the light reflective portion can have a convex form.

Each of the first and second light scattering portions can have a substantially linear form. Alternatively, each of the first and second light scattering portions has a substantially arcuate form. In some embodiments the first and second light scattering portions have a concave form such that an inner surface of each of the light scattering portions projects in to the interior volume of the component. Alternatively, the first and second light scattering portions can have a convex form.

In some embodiments the light reflective portion and the first and second light scattering portions define a cross-section that is generally zig-zag in form. In other embodiments the light reflective portion and the first and second light scattering portions define a cross-section that is generally v-shaped. In yet other embodiments the light reflective portion and the first and second light scattering portions define a cross-section that is generally elliptical in form.

The light various portions of the component can be integrally formed as a unitary component by for example co-extruding the portions of the component. Preferably, the component comprises polycarbonate.

Other embodiments of the invention pertain to LED-based lamps that utilize the optical component of the invention. According to one embodiment an LED-based lamp comprising: a linear array of LEDs operable to generate white light and an elongated optical component having a direction of elongation, comprising: a first light scattering portion extending along the direction of elongation and comprising a light scattering material; a second light scattering portion extending along the direction of elongation and comprising a light scattering material; and a light reflective portion extending along the direction of elongation, wherein the light reflective portion separates the first and second scattering portions, wherein the light reflective portion, the first scattering portion and the second scattering portion define an interior volume and a cross-section having a line of symmetry through the light reflective portion, and wherein the component is mountable over the linear array of LEDs such that the LEDs are housed within the interior volume.

Preferably, the component is mountable over the linear array of LEDs such that light reflective portion overlays the principal axis of the LEDs.

Advantageously, the component is configured such that the lamp generates between about 75% and about 95% of the total emitted light over angle greater than about ±30° to the line of symmetry of the component. Preferably, the component is configured such that the lamp generates about 90% of the total emitted light over angle greater than about ±30° to the line of symmetry of the component. Additionally, the component is configured such that the lamp generates about 40% of the total emitted light over angle between about ±55° and about ±90° to the line of symmetry of the component. The component can be configured such that the lamp generates about 10% of the total emitted light over angle between about ±90° and ±55° to the line of symmetry of the component. The component can configured such that the lamp generates about 10% of the total emitted light over angle between about ±90° and ±55° to the line of symmetry of the component.

Other embodiments of the invention pertain to lighting arrangements that utilize the LED-based lamps of the invention. According to an embodiment of the invention a lighting arrangement comprises: a housing having a light reflective interior surface and at least one LED-based lamp as described above that is located within the housing. A particular advantage of lighting arrangements utilizing lamps in accordance with embodiments of the invention is that due to the enhanced side emission characteristic of the lamps this provides a substantial improvement in emission uniformity from the entire arrangement. A further advantage is that by tailoring the side emission characteristic this enables lighting arrangements to be constructed having a shallower profile (i.e. shallower housing) as compared with the known arrangements.

In the foregoing embodiments, the interior volume of the elongated optical component can comprise a cavity filled with air. In any embodiment of the invention, the interior volume can comprise a solid light transmissive medium such as for example a polycarbonate or silicone material. Preferably, the light transmissive medium comprises a material with an index of refraction which is the same as or substantially matches the index of refraction of the first and second wavelength conversion portions. Such an arrangement eliminates the air-conversion portion interface index of refraction mismatch and assists in coupling light into the wavelength conversion and/or scattering portions.

### DESCRIPTION OF THE DRAWINGS

In order that the present invention is better understood, LED-based lamps and lighting arrangements in accordance with the invention will now be described, by way of example only, with reference to the accompanying drawings in which like reference numerals are used to denote like parts, and in which:

FIG. 1 shows an example of a traditional ceiling-mountable troffer;

FIGS. 2A and 2B respectively show schematic end and perspective views of an LED-based lamp in accordance with an embodiment of the invention;

FIG. 3A is an end view of a wavelength conversion component of the LED-based lamp of FIGS. 2A and 2B;

FIG. 3B is the calculated emission characteristic of the wavelength conversion component of FIG. 3A for light emission orthogonal (90°) to the direction of elongation of the component;

FIG. 4A is the measured emission characteristic of the wavelength conversion component of FIG. 3A for light emission in directions relative to the direction of elongation of 0°, 30°, 60° and 90° the component;

FIG. 4B is the measured emission characteristic of the wavelength conversion component of FIG. 3A without a light reflective portion for light emission in directions relative to the direction of elongation of 0°, 30°, 60° and 90° the component;

FIG. 5 is a representation of the distribution of total light emission orthogonal (90°) to the direction of elongation of the component for wavelength conversion components in accordance with the invention;

FIG. 6A is an end view of a wavelength conversion component in accordance with another embodiment of the invention;

FIG. 6B is the calculated emission characteristic of the wavelength conversion component of FIG. 6A for light emission orthogonal (90°) to the direction of elongation of the component;

FIG. 6C is a schematic of an optical arrangement utilizing the component of FIG. 6A

FIG. 6D is the calculated emission characteristic of the optical arrangement of FIG. 6C for light emission orthogonal (90°) to the direction of elongation of the component;

FIG. 7 is a lighting arrangement, troffer, in accordance with an embodiment of the invention;

FIG. 8A is a schematic end of an LED-based lamp in accordance with an embodiment of the invention;

FIG. 8B is an end view of a wavelength conversion component of the LED-based lamp of FIG. 8A;

FIG. 9A is the calculated emission characteristic of the wavelength conversion component of FIG. 8A for light emission orthogonal (90°) to the direction of elongation of the component; and

FIG. 9B is the measured emission characteristic of the wavelength conversion component of FIG. 8A for light emission in directions relative to the direction of elongation of 0°, 30°, 60° and 90° the component.

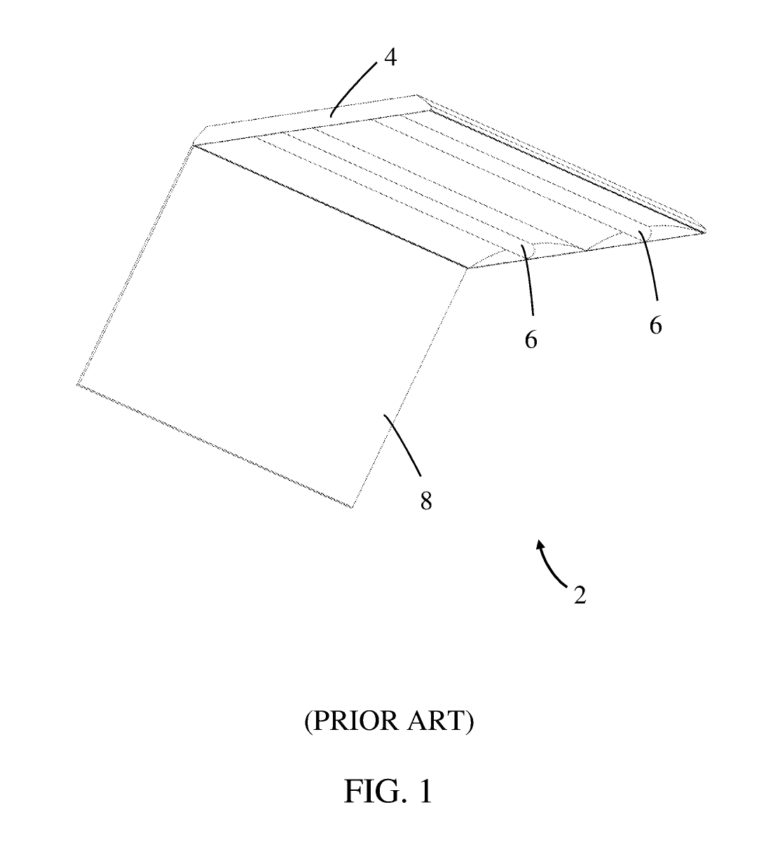

### DETAILED DESCRIPTION OF THE INVENTION

As previously discussed, conventional LED-based linear lamps can comprise a linear array of discrete white LEDs or a linear array of blue LED with a linear remote wavelength conversion component overlaying the LEDs. The problem with the conventional LED-based linear lamps is that they emit light having substantially Lambertian emission characteristics, which when used in troffer applications results in pronounced hotspots corresponding to the location of the LEDs. This means that such linear lamps typically cannot produce even distributions of light over wide angles, and that light at specific locations from such lamps (e.g., at locations directly adjacent to the LEDs) are much brighter than light from other portions of the lamp that are not directly beneath the LEDs. To increase the light emission uniformity in such troffer lighting arrangements, it is known to include a diffuser over the opening of the troffer body. Whilst use of a diffuser can improve the uniformity of emission and reduce hot spots and glare, the diffuser can significantly reduce the overall efficiency of the lighting arrangement.

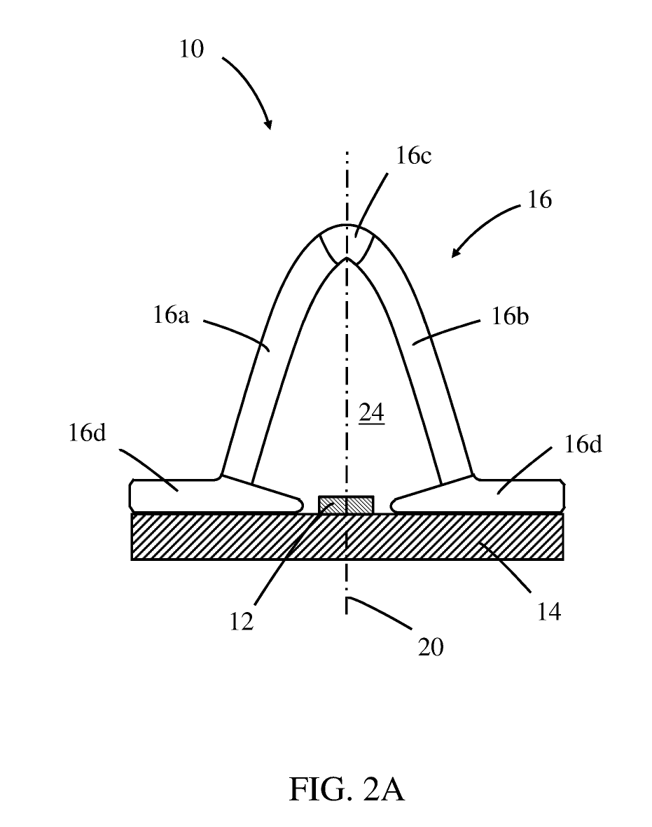

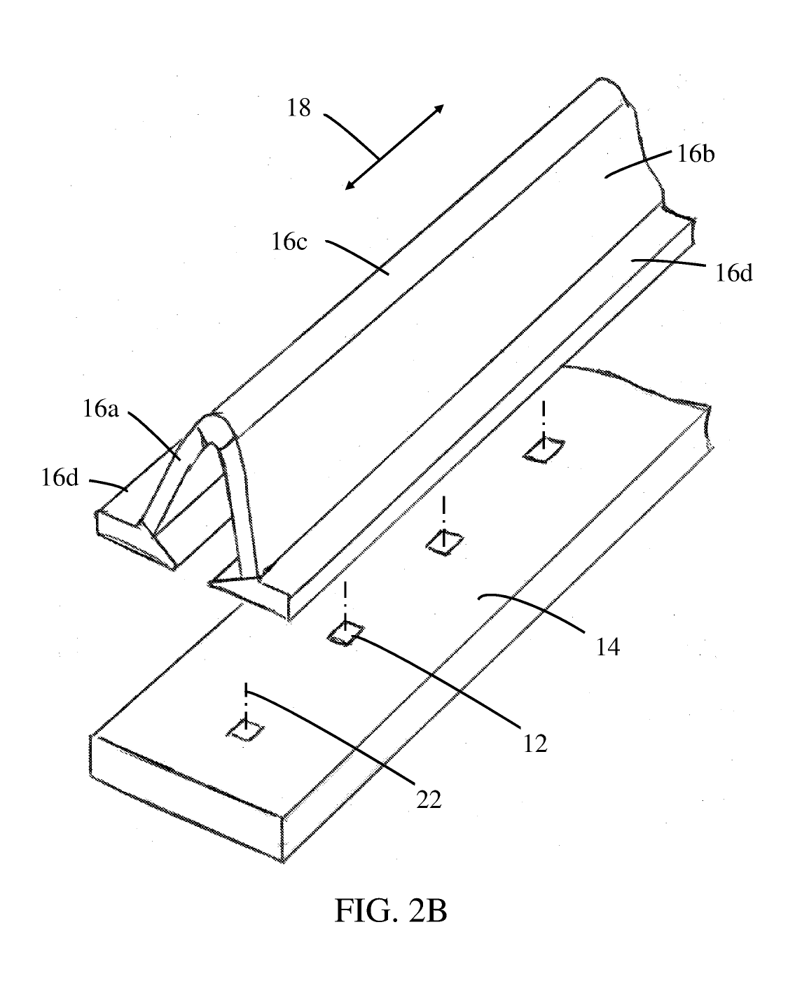

The present disclosure provides an improved approach to implement LED-based linear lamps that address these and other problems with the conventional solutions. FIGS. 2A and 2B illustrate an embodiment of an elongated LED-based lamp 10 according to some embodiments of the invention. The LED-based lamp 10 comprises a linear array of LEDs 12 that are arranged on a substrate (e.g., a circuit board) 14 and a hollow elongated wavelength conversion component 16. The wavelength conversion component 16 includes a first wavelength conversion wall portion 16a and a second wavelength conversion wall portion 16b. Each of these wavelength conversion wall portions 16a and 16b extends along the direction of elongation 18 of the component 16. These wavelength conversion wall portions 16a and 16b include one or more blue light excitable photoluminescence materials (e.g., phosphor materials). A light reflective portion 16c extends along the direction of elongation 18 of the component 16, where the light reflective portion 16c separates the first and second wavelength conversion wall portions 16a and 16b. The light reflective portion 16c includes a light reflective material (e.g., titanium dioxide). The component 16 is mounted adjacent to the substrate 14 having the linear array of LEDs 12. The wavelength conversion wall portions 16a, 16b in conjunction with the light reflective portion 16c define a hollow interior volume (cavity) 24. The cavity 24 is configured to enable the wavelength conversion component 16 to be mounted over the LEDs 12 such that the LEDS are located within the interior volume 24.

In operation, the photoluminescence materials within the wavelength conversion wall portions 16a and 16b absorb a portion of the excitation light emitted by the LEDs 12, and re-emit light of a different color (wavelength). In some embodiments, the LED chips generate blue light and the photoluminescence materials absorbs a percentage of the blue light and re-emits yellow light or a combination of green and red light, green and yellow light, green and orange or yellow and red light. The portion of the blue light generated by the LEDs 12 that is not absorbed by the photoluminescence material combined with the light emitted by the photoluminescence materials to provide light which appears to the eye as being nearly white in color. Alternatively, the LEDs 12 may generate ultraviolet (UV) light, in which the photoluminescence materials absorb the UV light to re-emit a combination of different colors of photoluminescence light that appear white to the human eye. UV light may be useful, for example, in combination with certain compatible phosphor materials such as blue and green light.

The placement and/or configuration of the light reflective portion 16c between the first wavelength conversion wall portion 16a and the second wavelength conversion wall portion 16b results in directed shaping of the light emission pattern that is radiated from the component 16. By having both the first wavelength conversion wall portion 16a and the second wavelength conversion wall portion 16b emit light from the sides of the component (i.e. in a direction that is orthogonal to the direction of elongation of the component), while preventing direct emissions of light from the central portion at the location of the light reflective portion 16c, this results in a “flattening” of the emission profile from the component 16, causing a more uniform emission of light over very wide emission angles. This means that a lamp having this component configuration can very efficiently provide greater levels of lighting uniformity, since excessive numbers of LEDs are not required to fill in the gaps between hotspots, as may be required using prior solutions. This also means that both lower costs and greater operating efficiencies can be achieved, since less LEDs are required to achieve equivalent lighting performance.

The wavelength conversion wall portions 16a and 16b can be formed of and/or include any suitable photoluminescence material(s). The photoluminescence material(s) may be included as a layer of material on an interior and/or exterior surface of a substrate layer. Alternatively, the photoluminescence material(s) may be distributed (e.g., uniformly distributed) within a carrier material.

In some embodiments, the photoluminescence materials comprise phosphors. For the purposes of illustration only, the current description may specifically refer to photoluminescence materials embodied as phosphor materials. However, the invention is applicable to any type of photoluminescence material, such as either phosphor materials or quantum dots. A quantum dot is a portion of matter (e.g. semiconductor) whose excitons are confined in all three spatial dimensions that may be excited by radiation energy to emit light of a particular wavelength or range of wavelengths. The one or more phosphor materials can include an inorganic or organic phosphor such as for example silicate-based phosphor of a general composition A₃Si(O,D)₅ or A₂Si(O,D)₄ in which Si is silicon, O is oxygen, A includes strontium (Sr), barium (Ba), magnesium (Mg) or calcium (Ca) and D includes chlorine (Cl), fluorine (F), nitrogen (N) or sulfur (S). Examples of silicate-based phosphors are disclosed in United States patents U.S. Pat. No. 7,575,697 B2 “Silicate-based green phosphors”, U.S. Pat. No. 7,601,276 B2 “Two phase silicate-based yellow phosphors”, U.S. Pat. No. 7,655,156 B2 “Silicate-based orange phosphors” and U.S. Pat. No. 7,311,858 B2 “Silicate-based yellow-green phosphors”. The phosphor can also include an aluminate-based material such as is taught in United States patents U.S. Pat. No. 7,541,728 B2 “Novel aluminate-based green phosphors” and U.S. Pat. No. 7,390,437 B2 “Aluminate-based blue phosphors”, an aluminum-silicate phosphor as taught in United States Patent U.S. Pat. No. 7,648,650 B2 “Aluminum-silicate orange-red phosphor” or a nitride-based red phosphor material such as is taught in co-pending United States patent application US2009/0283721 A1 “Nitride-based red phosphors” and International patent application W02010/074963 A1 “Nitride-based red-emitting in RGB (red-green-blue) lighting systems”. It will be appreciated that the phosphor material is not limited to the examples described and can include any phosphor material including nitride and/or sulfate phosphor materials, oxy-nitrides and oxy-sulfate phosphors or garnet materials (YAG).

Quantum dots can comprise different materials, for example cadmium selenide (CdSe). The color of light generated by a quantum dot is enabled by the quantum confinement effect associated with the nano-crystal structure of the quantum dots. The energy level of each quantum dot relates directly to the size of the quantum dot. For example, the larger quantum dots, such as red quantum dots, can absorb and emit photons having a relatively lower energy (i.e. a relatively longer wavelength). On the other hand, orange quantum dots, which are smaller in size can absorb and emit photons of a relatively higher energy (shorter wavelength). Additionally, daylight panels are envisioned that use cadmium free quantum dots and rare earth (RE) doped oxide colloidal phosphor nano-particles, in order to avoid the toxicity of the cadmium in the quantum dots. Examples of suitable quantum dots include: CdZnSeS (cadmium zinc selenium sulfide), CdₓZn₁₋ₓ Se (cadmium zinc selenide), CdSeₓS₁₋ₓ (cadmim selenium sulfide), CdTe (cadmium telluride), CdTeₓS₁₋ₓ (cadmium tellurium sulfide), InP (indium phosphide), InₓGa₁₋ₓ P (indium gallium phosphide), InAs (indium arsenide), CuInS₂ (copper indium sulfide), CuInSe₂ (copper indium selenide), CuInSₓSe₂₋ₓ (copper indium sulfur selenide), Cu InₓGa₁₋ₓ S₂ (copper indium gallium sulfide), CuInₓGa₁₋ₓSe₂ (copper indium gallium selenide), CuInₓAl₁₋ₓ Se₂ (copper indium aluminum selenide), CuGaS₂ (copper gallium sulfide) and CuInS₂ₓZnS₁₋ₓ (copper indium selenium zinc selenide). The quantum dots material can comprise core/shell nano-crystals containing different materials in an onion-like structure. For example, the above described exemplary materials can be used as the core materials for the core/shell nano-crystals. The optical properties of the core nano-crystals in one material can be altered by growing an epitaxial-type shell of another material. Depending on the requirements, the core/shell nano-crystals can have a single shell or multiple shells. The shell materials can be chosen based on the band gap engineering. For example, the shell materials can have a band gap larger than the core materials so that the shell of the nano-crystals can separate the surface of the optically active core from its surrounding medium. In the case of the cadmiun-based quantum dots, e.g. CdSe quantum dots, the core/shell quantum dots can be synthesized using the formula of CdSe/ZnS, CdSe/CdS, CdSe/ZnSe, CdSe/CdS/ZnS, or CdSe/ZnSe/ZnS. Similarly, for CuInS₂ quantum dots, the core/shell nanocrystals can be synthesized using the formula of CuInS₂/ZnS, CuInS₂/CdS, CuInS₂/CuGaS₂, CuInS₂/CuGaS₂/ZnS and so on.

In some embodiments, the substrate 14 comprises a MCPCB (Metal Core Printed Circuit Board). The metal core base of the MCPCB is mounted in thermal communication with a heat sink, e.g., with the aid of a thermally conducting compound such as for example a material containing a standard heat sink compound containing beryllium oxide or aluminum nitride. The heat sink is made of a material with a high thermal conductivity (typically ≧150 Wm⁻¹K⁻¹, preferably ≧200 Wm⁻¹K⁻¹) such as for example aluminum (≈250 Wm⁻¹K⁻¹), an alloy of aluminum, a magnesium alloy, a metal loaded plastics material such as a polymer, for example an epoxy.

As noted above, a plurality of LEDs 12 are mounted on the substrate 14. For the purposes of illustration, the term “LED” is used herein to refer to any type of solid-state light emitter and is not limited solely to light emitting diodes. The LEDs 12 can be configured as an array, e.g., in a linear array and/or oriented such that their principal emission axis is parallel with the projection axis of the lamp. The wavelength conversion component 10 is mountable over the linear array of LEDs 12 such that light reflective portion 16c overlays the principal emission axis of the LEDs 12.

In some embodiments the light reflective portion 16c extends along the entire length of the component 10 in the direction of elongation. In alternate embodiments, the light reflective portion 16c comprises a defined length that extends over only a portion of the component 10, e.g., directly over the specific locations of the LEDs 12.

In some embodiments, the first and second wavelength conversion wall portions 16a and 16b extend along the entire length of the component in the direction of elongation. In alternate embodiments, there may be one or more “breaks” in the extension of the first and second wavelength conversion wall portions 16a and 16b, e.g., to control the amount of emissions from certain portions of the lamp for emission pattern shaping purposes.

Each of the light reflective portion 16c, the first wavelength conversion wall portion 16a, and the second wavelength conversion wall portion 16b may have a consistent (constant) cross-section along the entire length of the component in the direction of elongation. In other embodiments, at least one of the light reflective portion 16c, the first wavelength conversion portion 16a, and the second wavelength conversion portion 16b does not have a consistent cross-section along the entire length of the component in the direction of elongation. This approach may be taken, for example, to change the relative dimensions of these portions at various points along the component 10, e.g., at the locations of the LEDs 12.

In some embodiments, the light reflective portion 16c, the first wavelength conversion wall portion 16a, and the second wavelength conversion wall portion 16b define consistent exterior dimensions along the entire length of the component in the direction of elongation. This is regardless of whether or not the individual dimensions of the light reflective portion 16c, the first wavelength conversion wall portion 16a, or the second wavelength conversion wall portion 16b differ from one part of the component to another part of the component. For example, the exterior shape of the component 10 stays the same through its entire length, but the light reflective portion 16c may change its shape as it extends through the component.

In some embodiments, the light reflective portion 16c, the first wavelength conversion portion wall 16a and second wavelength conversion wall portion 16b define a cross-section having a line of symmetry through the light reflective portion 16c. Such geometry provides an emission characteristic that is symmetrical about the line of symmetry. In an alternate embodiment, the light reflective portion 16c, the first wavelength conversion portion 16a and second wavelength conversion portion 16b define a cross-section that is not symmetrical through the light reflective portion 16c, e.g., to shape light emission that is dominant toward one side or the other of a lamp.

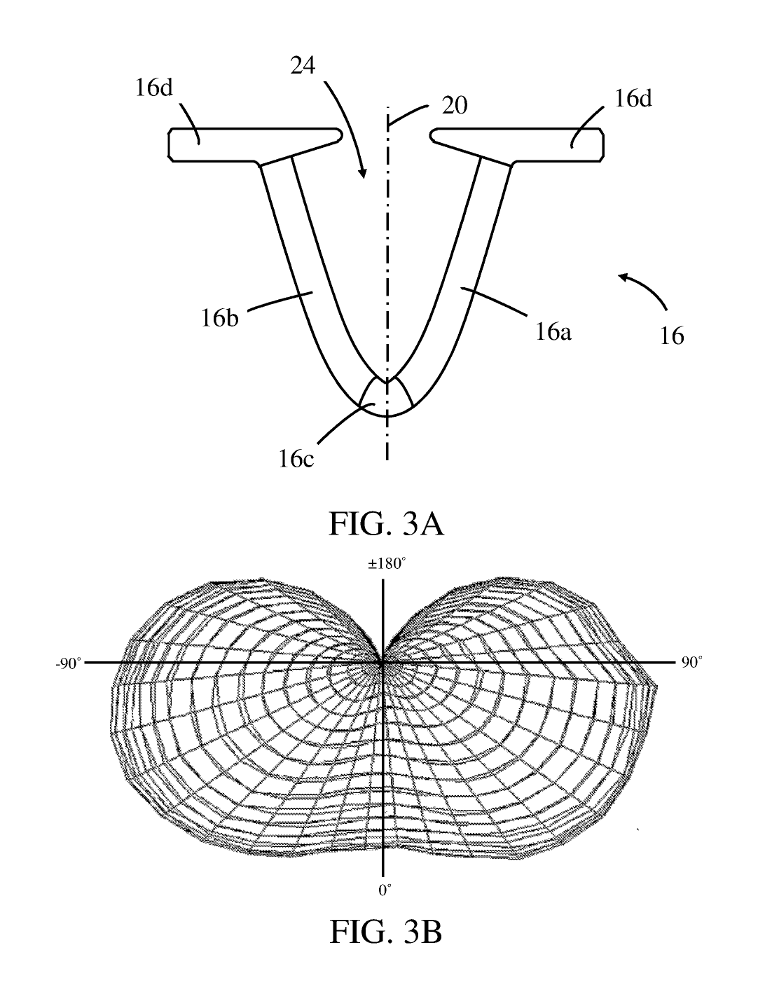

FIG. 3A is an end view of a wavelength conversion component 16 in accordance with an embodiment of the invention. As indicated in FIG. 3A the combination of the first wavelength conversion wall portion 16a, the second wavelength conversion wall portion 16b and the light reflective portion 16c define an overall cross-section of the component that is generally “v-shaped” or generally elliptical in form. In this embodiment the wavelength conversion wall portions 16a, 16b are arcuate (curved) in form. To ensure a symmetrical emission characteristic (i.e. symmetrical in directions orthogonal to the direction of elongation of the component) the first and second wavelength conversion portions are mirror images of each other, that is the component has a line of symmetry 20 passing through the light reflective portion.

Optionally, and as indicated in FIG. 3A, the component 16 may additionally comprise a pair of light reflective shoulder portions 16d that extend along the direction of elongation 18 of the component 16 and which project from a respective one of wavelength conversion portions 16a, 16b. The shoulder portions 16d are used for mounting the component to the array of LEDs. In some embodiments, the shoulder portions can further define a channel for receiving the substrate including the LEDs.

For ease of fabrication the light reflective portion 16c, the first wavelength conversion wall portion 16a and the second wavelength conversion wall portion 16c are integrally formed as a unitary component. In a preferred embodiment, the optical component is formed as a unitary component by co-extruding the various portions of the component. In some embodiments, the wavelength conversion component 16 comprises polycarbonate though it can comprise other light transmissive materials such as silicone. Alternatively, the component may be formed by injection molding or other manufacturing methods.

The photoluminescence material(s), which typically comprise an inorganic phosphor material, can be incorporated into and homogeneously distributed throughout the first and second wavelength conversion wall portions. Alternatively and/or in addition the photoluminescence material can be provided as a layer on a surface of the first and second wavelength conversion wall portions.

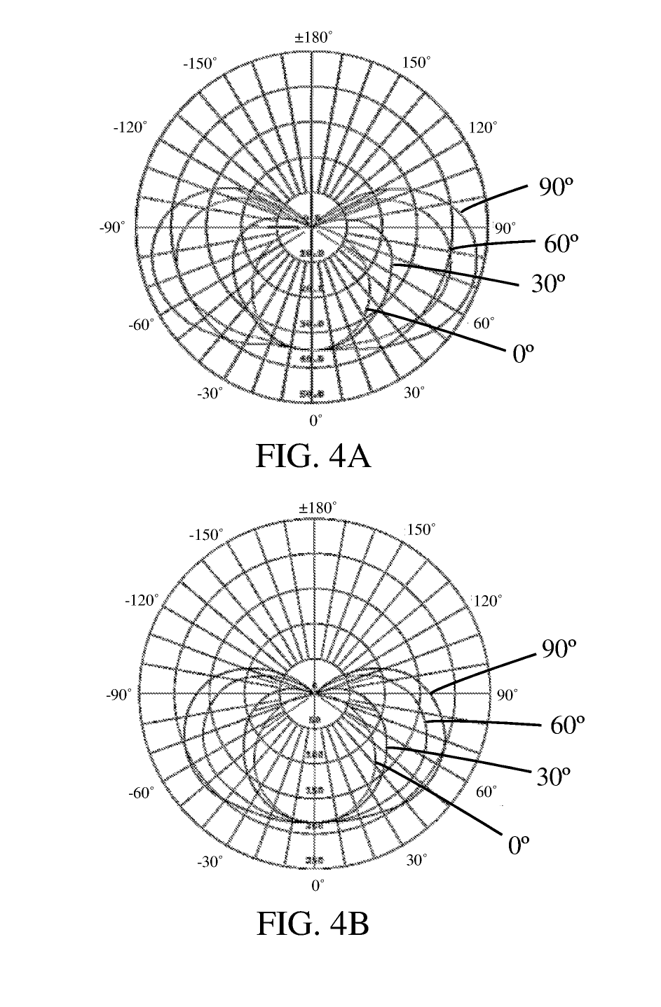

FIG. 3B illustrates the calculated emission characteristic of the wavelength conversion component 16 of FIG. 3A for light emission orthogonal (90°) to the direction of elongation 18 of the component. As can be seen from this figure, the emission characteristic in a direction orthogonal to the direction of elongation is non-Lambertian and has side lobes indicating that a significant proportion of light is being emitted out to the sides of the component. FIG. 4A is the measured emission characteristic of the wavelength conversion component of FIG. 3A in directions relative to the direction of elongation of the component of 0°, 30°, 60° and 90°. As can be seen there is a high correlation between the calculated and measured emission characteristics by comparing characteristic of FIG. 3B with that of the characteristic labeled 90° in FIG. 4A. Furthermore, the characteristic labeled 0° shows that the wavelength conversion component has an emission characteristic in a direction of elongation of the component that is substantially Lambertian.

FIG. 4B is a measured emission characteristic of a wavelength conversion component that does not include a light reflective portion. The component has exactly the same profile as that of FIG. 3A without a light reflective portion that is it has phototoluminescence material throughout its entire cross-section. By comparing the emission characteristics of FIG. 4B with that of FIG. 4A it will be apparent that the effect of the light reflective portion increases light emission to the sides of the component. Accordingly, it will be appreciated that through the placement and/or configuration of the light reflective portion between the first wavelength conversion portion and the second wavelength conversion portion the emission characteristic of the component can be tailored for an intended application.

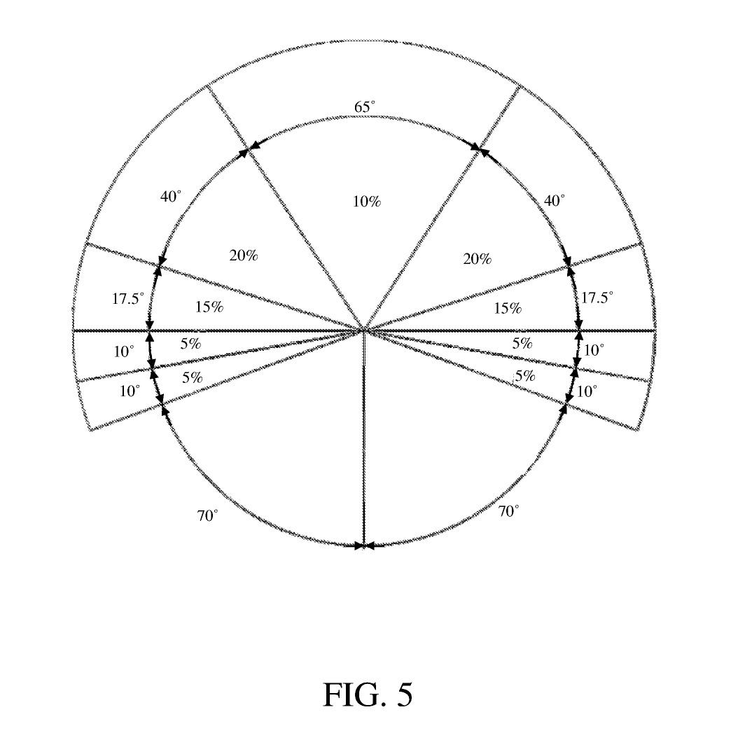

FIG. 5 is a visual representation of the distribution of total light emission orthogonal (90°) to the direction of elongation of the component for wavelength conversion components in accordance with the invention. FIG. 5 indicates that about 10% of the total light emission is within about ±32.5° in other words about 90% of light is emitted at angles of greater than about 32.5°. The figure further indicates that between about 75% and about 95%, preferably about 90% of the totally emitted light over angle greater than about ±30° to the line of symmetry of the wavelength conversion component. In some embodiments, the wavelength conversion component can be configured such that it generates about 40% of the totally emitted light over angle between about ±55° and about ±90° to the line of symmetry of the wavelength conversion component. The wavelength conversion component can be configured such that it generates about 10% of the totally emitted light over angle between about ±90° and ±55° to the line of symmetry of the wavelength conversion component.

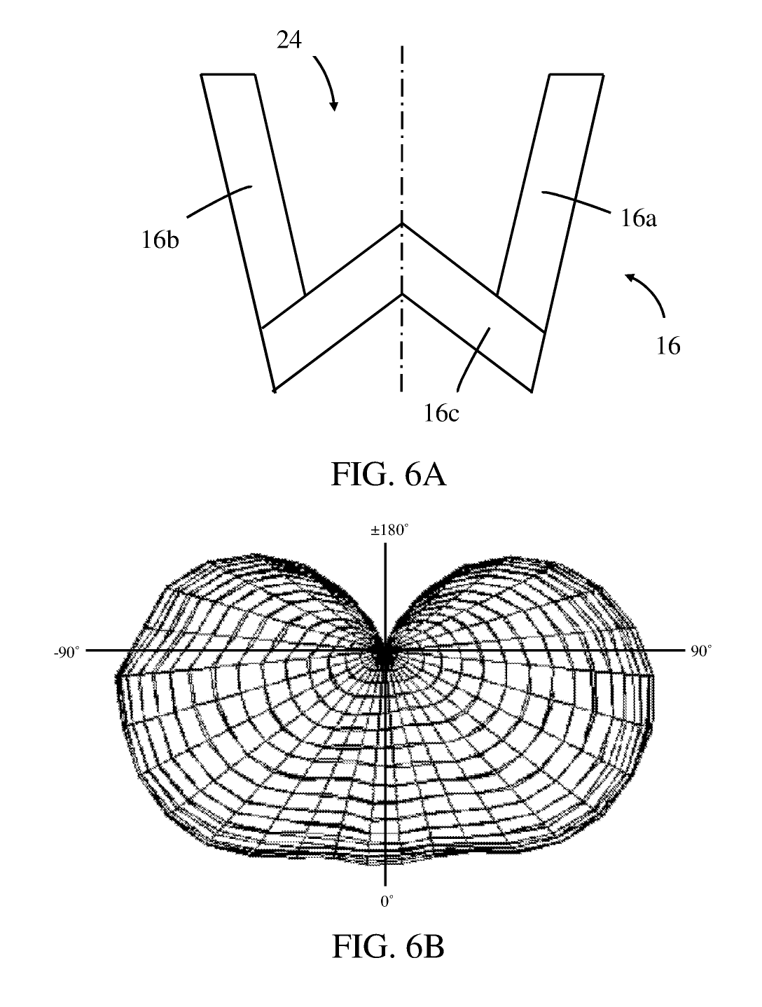

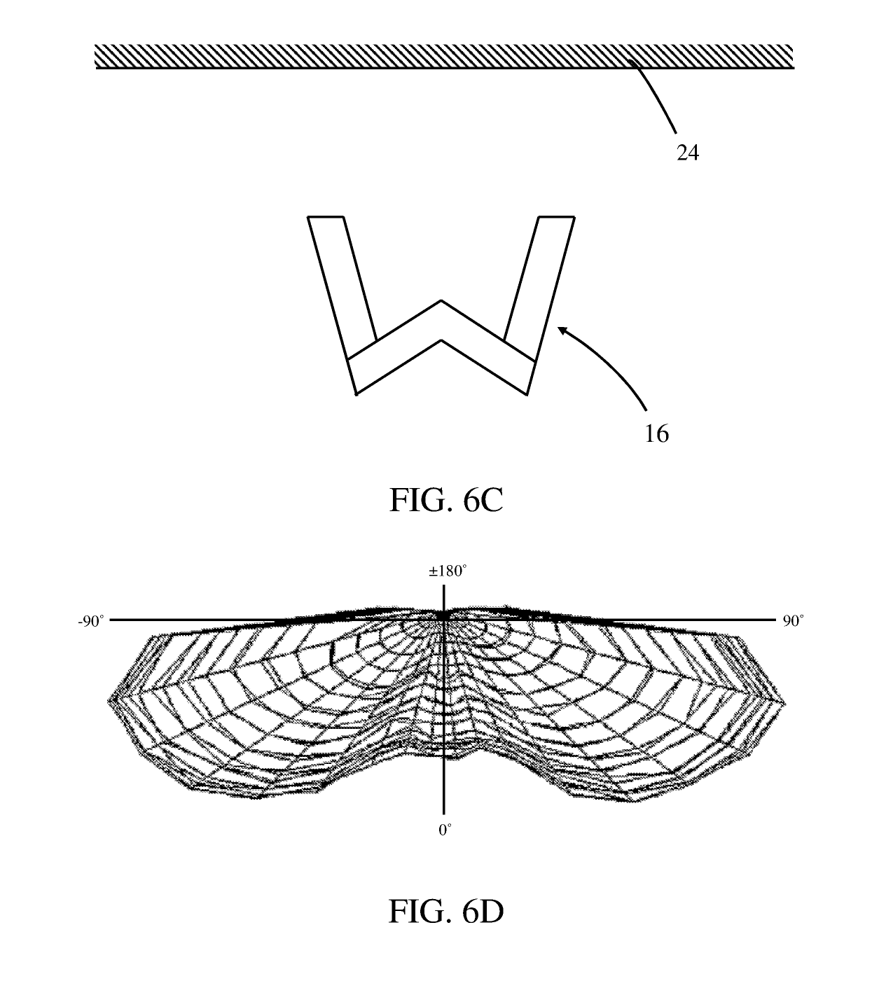

As illustrated in FIG. 6A, the light reflective portion 16c, the first wavelength conversion portion 16a, and the second wavelength conversion portion 16c can define an interior volume and the light reflective portion 16c has an angled form such that an inner surface of the light reflective portion 16c projects in to the interior volume of the wavelength conversion component. FIG. 6C illustrates this configuration is aligned with a back reflector 24.

FIG. 6B is a measured emission characteristic of a wavelength conversion component of FIG. 6A that does not include the back reflector 24. FIG. 6D is a measured emission characteristic of a wavelength conversion component of FIG. 6C that does include the back reflector 24. By comparing the emission characteristics of FIG. 6B with that of FIG. 6D it will be apparent that the effect of the back reflector 24 is to minimize light emission to the cenral portion of the component.

Each of the first and second wavelength conversion portions can have a substantially linear form. Alternatively, each of the first and second wavelength conversion portions can have a substantially arcuate form.

The first and second wavelength conversion portions can have a concave form such that an inner surface of each of the wavelength conversion portions project in to the interior volume of the wavelength conversion component. Alternatively, the first and second wavelength conversion portions have a convex form.

In some embodiments the light reflective portion, the first wavelength conversion portion and second wavelength conversion portions define a cross-section that is generally zig-zag in form, that is has a cross-section that resembles a letter W. In other embodiments, the light reflective portion, the first wavelength conversion portion and second wavelength conversion portions define a cross-section that is generally v-shaped or elliptical in form.

The photoluminescence material, which can typically comprise an inorganic phosphor material, can be incorporated into and homogeneously distributed throughout the first and second wavelength conversion portions. Alternatively and/or in addition the photoluminescence material can be provided as a layer on a surface of the first and second wavelength conversion portions.

For ease of fabrication the light reflective portion, the first wavelength conversion portion and the second wavelength conversion portion are integrally formed as a unitary component. In a preferred embodiment the optical component is formed as a unitary component by co-extruding the light reflective portion, the first wavelength conversion portion and the second wavelength conversion portion. Alternatively, the component may be formed by injection molding.

Preferably, the various regions of the wavelength conversion component comprise polycarbonate.

Other embodiments of the invention pertain to LED-based lamps that utilize the wavelength conversion components of the invention. According to one embodiment an LED-based lamp comprises: a linear array of LEDs operable to generate excitation light and an elongated wavelength conversion component having a direction of elongation, comprising: a first wavelength conversion portion extending along the direction of elongation of the component, wherein the first wavelength conversion portion comprises at least one photoluminescence material which is excitable by the excitation light; a second wavelength conversion portion extending along the direction of elongation of the component, wherein the second wavelength conversion portion comprises at least one photoluminescence material which is excitable by the excitation light; and a light reflective portion extending along the direction of elongation of the component, wherein the light reflective portion separates the first and second wavelength conversion portions, wherein the light reflective portion, the first wavelength conversion portion and second wavelength conversion portions define an interior volume and a cross-section having a line of symmetry through the light reflective portion, and wherein the wavelength conversion component is mountable over the linear array of LEDs such that the LEDs are housed within the interior volume. Typically, all light emitted from the lamp passes through one of the first and second wavelength conversion portions.

In preferred embodiments the LEDs have a principle emission axis and the wavelength conversion component is mountable over the linear array of LEDs such that light reflective portion overlays the principle axis of the LEDs.

In some embodiments the wavelength conversion component is configured such that the lamp generates between about 75% and about 95%, preferably about 90% of the totally emitted light over angle greater than about ±30° to the line of symmetry of the wavelength conversion component. The wavelength conversion component can be configured such that the lamp generates about 40% of the totally emitted light over angle between about ±55° and about ±90° to the line of symmetry of the wavelength conversion component. The wavelength conversion component can be configured such that the lamp generates about 10% of the totally emitted light over angle between about ±90° and ±55° to the line of symmetry of the wavelength conversion component.

Other embodiments of the invention pertain to lighting arrangements that utilize the LED-based lamps of the invention. According to an embodiment of the invention a lighting arrangement comprises: a housing having a light reflective interior surface and at least one LED-based lamp as described above that is located within the housing. A particular advantage of lighting arrangements utilizing lamps in accordance with embodiments of the invention is that due to the enhanced side emission characteristic of the lamps this provides a substantial improvement in emission uniformity from the entire arrangement. A further advantage is that by tailoring the side emission characteristic this enables lighting arrangements to be constructed having a shallower profile (i.e. shallower housing) as compared with the known arrangements.

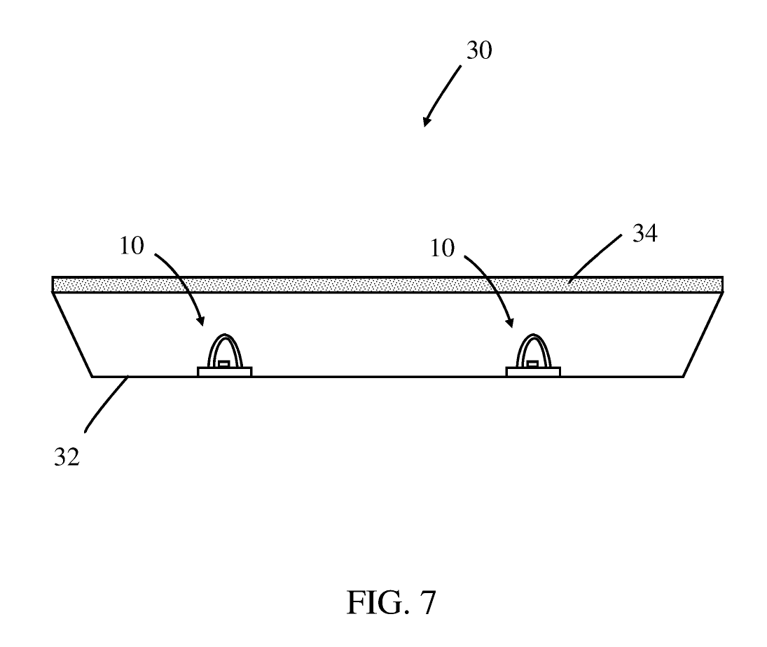

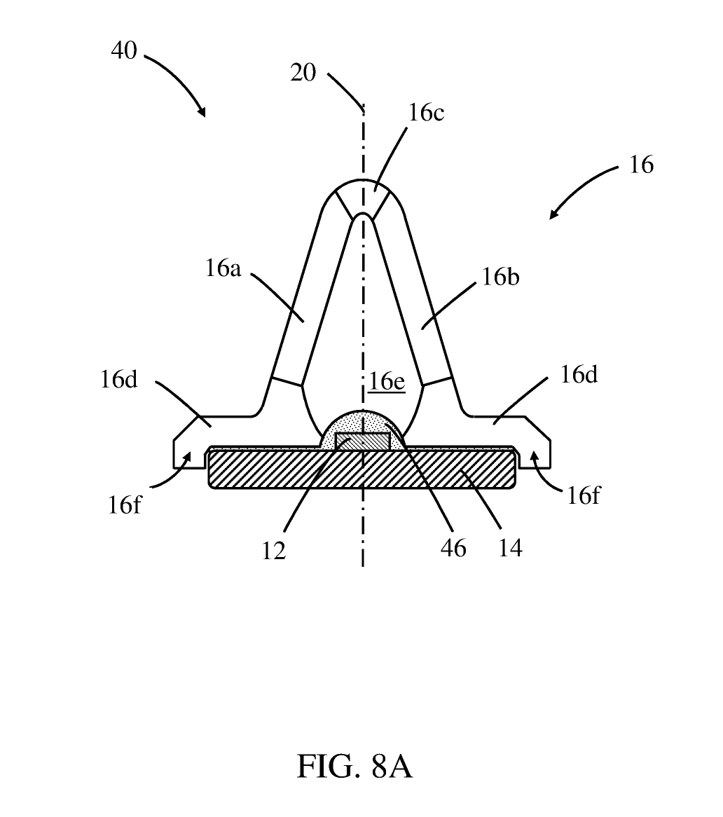

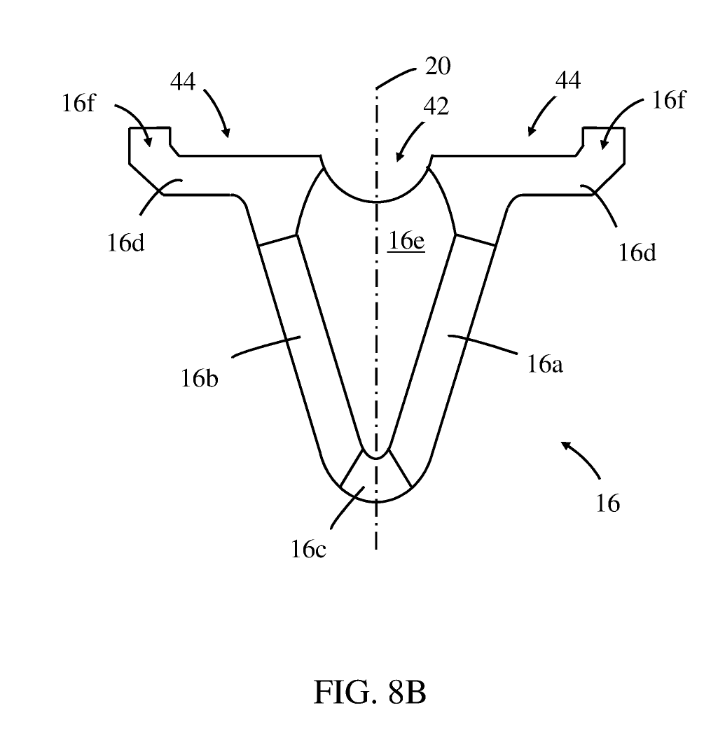

FIG. 7 illustrates a lighting arrangement, troffer, 30 in accordance with an embodiment of the invention that utilizes the LED-based lamps 10 of the invention. The lighting arrangement comprises a troffer body 32 that houses a plurality of LED-based lamps 10 as described above. To maximize light emission from the arrangement, the troffer body 32 comprises an inner surface that is highly light reflective (i.e. has a reflectance of 95 or greater). To reduce “hot spots” or glare, the lighting arrangement can further comprise a light diffusive cover 34 overlaying the troffer body opening. The inventor has discovered that it possible to implement a two foot by two foot troffer using only two LED-based lamps according to the invention while still achieving a virtually uniform emission characteristic. It will be understood that, in another embodiment, the troffer 30 of FIG. 7 can utilize the LED-based lamps 40, as described in FIG. 8A for example.

Wavelength Conversion Components with Solid Light Transmissive Core

In the foregoing embodiments the wavelength conversion wall portions 16a, 16b in conjunction with the light reflective portion 16c define a hollow interior volume (cavity) 24. In any embodiment of the invention, the interior volume 24 can comprise a solid light transmissive medium.

FIG. 8A illustrates an embodiment of an elongated LED-based lamp 40 according to some embodiments of the invention in which the wavelength conversion component 16 further comprises a solid light transmissive core 16e. The LED-based lamp 40 comprises a linear array of LEDs 12 that are arranged on a substrate (e.g., a circuit board) 14 and an elongated wavelength conversion component 16.

FIG. 8B is an end view of a wavelength conversion component 16 in accordance with an embodiment of the invention. The wavelength conversion component 16 can along its direction of elongation comprise: first and second wavelength conversion portions 16a, 16b; a light reflective portion 16c disposed between the first and second wavelength conversion portions 16a, 16b; light reflective shoulder portions 16d; and a solid light transmissive core 16e. As indicated in FIG. 8B, the combination of the first and second wavelength conversion portions 16a, 16b and the light reflective portion 16c define an overall cross-section of the component that is generally “triangular-shaped” in form. In this embodiment, the wavelength conversion wall portions 16a, 16b are substantially straight in form. To ensure a symmetrical emission characteristic (i.e. symmetrical in directions orthogonal to the direction of elongation of the component) the first and second wavelength conversion portions are mirror images of each other, that is the component has a line of symmetry 20 passing through the light reflective portion 16e.

The light reflective shoulder portions 16d extend along the direction of elongation 18 of the component 16 and project from a respective one of wavelength conversion portions 16a, 16b. The shoulder portions 16d are used for mounting the component to the array of LEDs. As indicated in FIG. 8B, each shoulder portion 16d can further include a respective foot projection 16f such that the light reflective portions 16d in conjunction with the foot projections 16f define a rectangular channel 44 for receiving the substrate 14 including the LEDs 12. As shown in FIG. 8A the foot projections partially extend over the lateral edges of the substrate 14.

The light transmissive core 16e can comprise any light transmissive medium such as for example a polycarbonate or silicone material. Preferably, the light transmissive medium comprises a material with an index of refraction which is the same as or substantially matches the index of refraction of the first and second wavelength conversion portions 16a, 16b. By providing a solid light transmissive core 16e this eliminates the air to conversion portion interface index of refraction mismatch and this assists in coupling light into the wavelength conversion portions.

The solid light transmissive core 16e further comprises a channel 42 that projects into the light transmissive core 16e in a direction towards the light reflective portion 16c. The channel 42 is configured to enable the wavelength conversion component 16 to be mounted over the LEDs 12 such that they are located within the channel 42. As shown in FIG. 8B the channel 42 can be semicircular in form. As indicated in FIG. 8A, the channel 42 is filled with a light transmissive medium 44 such as for example a polycarbonate or epoxy when the component 16 is mounted on the substrate 14. The inclusion of the light transmissive medium any air-interfaces and maximizes coupling of light from the LEDs into the light conversion portions.

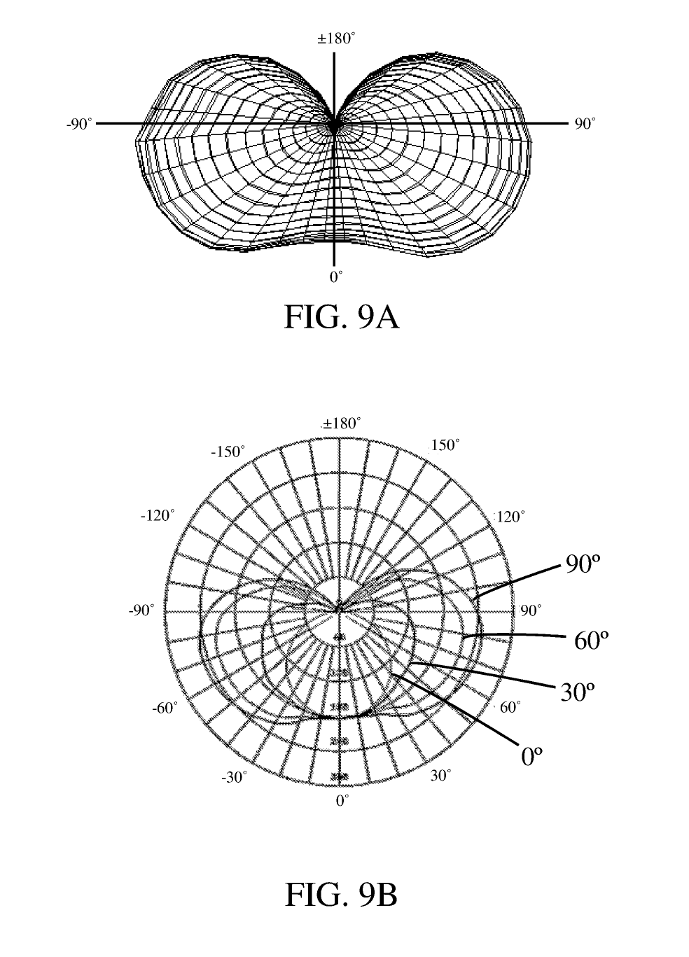

FIG. 9A illustrates the calculated emission characteristic of the wavelength conversion component 16 of FIG. 8B for light emission orthogonal (90°) to the direction of elongation of the component. As can be seen from this figure the emission characteristic in a direction orthogonal to the direction of elongation is non-Lambertian and has side lobes indicating that a significant proportion of light being is emitted out to the sides of the component. FIG. 9B is the measured emission characteristic of the wavelength conversion component of FIG. 8B in directions relative to the direction of elongation of the component of 0°, 30°, 60° and 90°. As can be seen, there is a high correlation between the calculated and measured emission characteristics by comparing characteristic of FIG. 9A with that of the characteristic labeled 90° in FIG. 9B. Furthermore, the characteristic labeled 0° shows that the wavelength conversion component has an emission characteristic in a direction of elongation of the component that is substantially Lambertian.

### White LED Lighting Arrangements and Light Scattering Component

Whilst embodiments concern linear lamps and lighting arrangements that utilize a wavelength conversion component to convert LED generated light, typically blue, to white light, embodiments of the present invention also finds utility in applications that use white LEDs. In such applications the elongated optical component comprises a light scattering material in place of the one or more photoluminescence materials of the wavelength conversion regions. The light scattering material, which is typically in the form of particles, is preferably incorporated into and homogeneously distributed throughout the first and second scattering portions of the component. Alternatively and/or in addition the light scattering material can be provided as a layer on a surface of the first and second scattering portions. The light scattering material can comprise: zinc oxide, titanium dioxide, barium sulfate, magnesium oxide, silicon dioxide, aluminum oxide, zirconium dioxide or mixtures thereof.

Although the present invention has been particularly described with reference to certain embodiments thereof, it should be readily apparent to those of ordinary skill in the art that changes and modifications in the form and details may be made without departing from the spirit and scope of the invention.

For example, whilst embodiments of the invention have been described in relation to troffer-based lighting arrangements, the wavelength conversion component and LED-based lamps utilizing such components find utility in other linear lighting arrangements including, but not limited to, suspended linear lighting arrangements, surface mountable linear lighting arrangements such as wraparound lights or wrap lights, and task lighting arrangements.

Moreover, in the exemplary embodiments described the wavelength conversion component has a cross-section that is consistent along the entire length of the component. In this patent specification, cross-section encompasses not only the overall shape but also the constituent portions (light reflective and wavelength conversion portions) defining the cross-section. It is envisioned in other embodiments that the cross-section may be different at different points along the length of the component. For example, the overall shape or profile of the component may vary along the length or the light reflective portion may not run the entire length of the component.

What is claimed is:

1. An elongated wavelength conversion component having a direction of elongation, comprising:
a first wavelength conversion portion extending along the direction of elongation and comprising at least one photoluminescence material;
a second wavelength conversion portion extending along the direction of elongation and comprising at least one photoluminescence material; and
a light reflective portion extending along the direction of elongation,
wherein the light reflective portion separates the first and the second wavelength conversion portions.

2. The component of claim 1, wherein the light reflective portion extends along the entire length of the component in the direction of elongation.

3. The component of claim 1, wherein the first and second wavelength conversion portions extend along the entire length of the component in the direction of elongation.

4. The component of claim 1, wherein each of the light reflective portion, the first wavelength conversion portion, and the second wavelength conversion portion have a consistent cross-section along the entire length of the component in the direction of elongation.

5. The component of claim 1, wherein the light reflective portion, the first wavelength conversion portion and second wavelength conversion portions define a cross-section having a line of symmetry through the light reflective portion.

6. The component of claim 1, wherein at least one of the first wavelength conversion portion, second wavelength conversion portion and light reflective portion has a convex form.

7. The component of claim 1, wherein each of the first and second wavelength conversion portions has a substantially linear form.

8. The component of claim 1, wherein each of the first and second wavelength conversion portions has an arcuate form.

9. The component of claim 1, wherein at least one of the first wavelength conversion portion, second wavelength conversion portion and light reflective portion has a concave form.

10. The component of claim 1, wherein the light reflective portion, the first wavelength conversion portion and the second wavelength conversion portions define a cross-section that is generally zig-zag in form.

11. The component of claim 1, wherein the light reflective portion, the first wavelength conversion portion and the second wavelength conversion portions define a cross-section that is generally v-shaped.

12. The component of claim 1, wherein the light reflective portion, the first wavelength conversion portion and the second wavelength conversion portions define a cross-section that is generally elliptical in form.

13. The component of claim 1, wherein the photoluminescence material is distributed throughout the first and second wavelength conversion portions.

14. The component of claim 1, wherein the photoluminescence material is provided as a layer on a surface of the first and second wavelength conversion portions.

15. The component of claim 1, wherein the light reflective portion, the first wavelength conversion portion, and the second wavelength conversion portion define an interior volume, and said interior volume comprises a light transmissive medium.

16. The component of claim 1, wherein the optical component is formed by co-extrusion of the light reflective portion, the first wavelength conversion portion and the second wavelength conversion portion.

17. The component of claim 1, wherein the wavelength conversion component comprises polycarbonate.

18. An LED-based lamp comprising: a linear array of LEDs operable to generate excitation light and an elongated wavelength conversion component having a direction of elongation, comprising:
a first wavelength conversion portion extending along the direction of elongation and comprising at least one photoluminescence material which is excitable by the excitation light;
a second wavelength conversion portion extending along the direction of elongation and comprising at least one photoluminescence material which is excitable by the excitation light; and
a light reflective portion extending along the direction of elongation of the component, wherein the light reflective portion separates the first and the second wavelength conversion portions,
wherein the light reflective portion, the first wavelength conversion portion and second wavelength conversion portions define an interior volume and a cross-section having a line of symmetry through the light reflective portion,
and wherein the wavelength conversion component is mountable over the linear array of LEDs such that the LEDs are housed within the interior volume.

19. The lamp of claim 18, wherein the LEDs have a principal emission axis and wherein the component is mountable over the linear array of LEDs such that light reflective portion overlays the principal axis of the LEDs.

20. An elongated optical component having a direction of elongation, comprising:
a first light scattering portion extending along the direction of elongation and comprising a light scattering material;
a second light scattering portion extending along the direction of elongation and comprising a light scattering material; and
a light reflective portion extending along the direction of elongation, wherein the light reflective portion separates the first and second light scattering portions.
